(19) United States
(12) Patent Application Publication
(10) Pub. No.: US 2025/0156521 A1
(43) Pub. Date: May 15, 2025

(54) PROCEDURE FOR SUCCESSFULLY EXECUTING AN APP ON A MEASURING TRANSDUCER, MEASURING TRANSDUCER, COMPUTER PROGRAM PRODUCT AND COMPUTER-READABLE MEDIUM

(71) Applicant: Endress+Hauser Conducta GmbH+Co. KG, Gerlingen (DE)

(72) Inventors: Stefan Kempf, Kornwestheim (DE); Stefan Robl, Hünxe (DE)

(21) Appl. No.: 18/943,191

(22) Filed: Nov. 11, 2024

(30) Foreign Application Priority Data
Nov. 10, 2023 (DE) 10 2023 131 228.6

(51) Int. Cl. G06F 21/44; G06F 9/48

(52) U.S. Cl. CPC G06F 21/44; G06F 9/4881

(57) ABSTRACT

A system call is provided from a measuring transducer having an app. The app executes threads at runtime. It is determined which system calls each thread is authorized to use, and which thread is executed in which process. The method includes: checking using a first matrix whether the thread uses the system call(s) to which it is authorized: if authorized, an execution of the system call takes place, if no, the app is terminated; checking using a second matrix whether a process calls those functions that a thread makes available to it: if authorized, an execution of the function takes place, if no, treatment as a firmware implementation error in the host takes place; and checking using a third matrix whether a process executes the threads assigned thereto: if authorized, the thread is executed by the process, if no, treatment as a firmware implementation error in the host takes place.

### CROSS-REFERENCE TO RELATED APPLICATION

The present application is related to and claims the priority benefit of German Patent Application No. 10 2023 131 228.6, filed on Nov. 10, 2024, the entire contents of which are incorporated herein by reference.

### TECHNICAL FIELD

The present disclosure relates to a procedure for successfully executing an app on a measuring transducer of process automation technology, a corresponding measuring transducer, a computer program product and a computer-readable medium.

### BACKGROUND

DE 10 2016 124 326 discloses a procedure for operating a measuring transducer in process automation technology. A measuring transducer is sometimes also called a transmitter. DE 10 2016 124 326 describes the subsequent expandability of a measuring transducer without having to replace its operating software. The described measuring transducer can load and run “apps.”

When executing these apps on a measuring transducer, it can happen that activities have to be executed quasi-parallel, for example signal processing to calculate the measured values and read out a parameter or generally access to a parameter system in order to display measured values on a display (“GUI”, graphical user interface).

Signal processing usually consists of computationally intensive and therefore lengthy operations. Access to the parameter system, on the other hand, is processed quite quickly, since it only involves exchanging the values stored there. However, the GUI system requires the highest possible processing speed to avoid delays for the user during operation (“jerky” response to user input, e.g., when scrolling). However, in order to display the data, the GUI system must frequently (sometimes many times per second) access parameters (setting parameters or measured values) that are managed within the parameter system.

A general-purpose operating system (GPOS) is a complete operating system that supports process management, memory management, input/output devices, file systems, and user interfaces, thus allowing the execution of almost any application. In a GPOS, processes are created dynamically to execute user commands.) In a GPOS, from the perspective of the operating system, all threads are equivalent, even if they contain different application logic. Equivalent in this sense means:
the individual threads can be allocated to all available processors; when using dynamic scheduling, this allocation may change continuously.
all threads have access to the same operating system functions
the threads have a priori the same priority in the allocation of processors

In a measuring transducer with limited computing power, without GPOS and existing firmware without app functionality, the initial situation is different: the software comprises several (usually statically predefined) operating system processes in which the application logic and other necessary functionalities are situated. The operating system processes with application logic are therefore not equivalent, but perform specialized tasks. Moving existing application logic between operating system processes is often only possible with major refactoring efforts, if at all. If new application logic is to be added, it must be implemented within the appropriate operating system processes.

Since this also affects application logic within apps. it is more difficult to add app functionality to an existing measuring transducer without GPOS than it would be with a system based on a GPOS.

### SUMMARY

The present disclosure is based on the object of ensuring the successful execution of the apps in a measuring transducer whose functionality can be extended by apps, without necessarily requiring a GPOS in the measuring transducer.

The object is achieved by a procedure for successfully executing an app on a measuring transducer of process automation technology, wherein the firmware of the measuring transducer is designed to receive and store apps, wherein the measuring transducer is designed to execute one or more processes, the procedure comprising the steps of: providing system calls from the measuring transducer; transmitting the app to the measuring transducer if the app is not yet located on the measuring transducer, wherein the app comprises at least program code with at least one app function, and generates and executes one or more threads at runtime, wherein each app function is assigned to one or more threads, wherein it is determined which system calls each thread is authorized to use, and wherein it is determined which thread is executed in which process; and executing the app on the measuring transducer; and at least one of the procedure steps a), b), and/or c), comprising

a) checking at runtime by means of a first authorization matrix whether the thread actually only uses the system call(s) to which the thread is authorized:
if authorization is present, an execution of the system call takes place, and
if no authorization is present, the app is terminated;

b) checking at runtime by means of a second authorization matrix whether a process only calls those functions that a thread makes available to it:
if authorization is present, an execution of the function takes place, and
if no authorization is present, treatment as a firmware implementation error in the host takes place;

c) checking at runtime by means of a third authorization matrix whether a process only executes the threads assigned thereto:
if authorization is present, the thread is executed by the process, and
if no authorization is present, treatment as a firmware implementation error in the host takes place.

Therefore, the procedure steps under only a), under only b), under only c), under a) and b), under a) and c), under b) and c), and under a), b) and c) can be executed.

In the following, the term “app” is used synonymously with the term “plug-in” and is a downloadable program code which brings a useful functionality. Furthermore, the term “basic system” is used synonymously with “host”. This includes the firmware of the measuring transducer.

One embodiment provides that the basic system comprises a plurality of apps.

One embodiment provides that a system call can be called by more than one thread and that the shared resources are jointly protected against parallel access by a suitable protection mechanism, by locks in shared memory models and message passing in isolated memory models.

One embodiment provides that a system call and threads that call it are mapped to a single process.

One embodiment provides that the step of checking at runtime by means of the first authorization matrix whether the thread actually only uses the system call(s) to which the thread is authorized comprises one or more of the following measures:
per system call: a bit vector with length equal to the number of threads, set bit i means thread is allowed to call the relevant system call;
per thread: a bit vector with length equal to the number of system calls, set bit i means thread is allowed to call system call;
per system call: sorted list of unique thread identifiers i that are allowed to call the system call, wherein by means of a binary search it is checked whether the system call is allowed to be called by a thread;
per thread: sorted list of unique system call identifiers i that a thread is allowed to call, wherein by means of a binary search it is checked whether the thread is allowed to call a system call;
per system call: balanced binary search tree of unique thread identifiers i, corresponding to the threads that are allowed to call system calls;
per thread: balanced binary search tree of unique system call identifiers i, corresponding to the system calls that the thread is allowed to call;
per system call: hash table of unique thread identifiers i, corresponding to the threads that are allowed to call the system call;
per thread: hash table of unique system call identifiers i, corresponding to the system calls that the thread is allowed to call.

One embodiment provides that the step of checking at runtime by means of a second authorization matrix whether a process only calls those functions that a thread makes available to it includes one or more of the following measures:
per app function: a bit vector with length equal to the number of threads, set bit i means thread is allowed to call the relevant app function;
per thread: a bit vector with length equal to the number of app functions, set bit i means thread is allowed to call app function;
per app function: sorted list of unique thread identifiers that are allowed to call the app function, wherein by means of a binary search it is checked whether the app function is allowed to be called by a thread in that the binary search searches for the thread identifier of the calling thread in the sorted list of unique thread identifiers;
per thread: sorted list of unique app function identifiers that a thread is allowed to call, wherein by means of a binary search it is checked whether the thread is allowed to call an app function in that the binary search searches for the app function identifier of the app function to be called in the sorted list of unique app function identifiers;
per app function: balanced binary search tree of unique thread identifiers that are allowed to call app functions;
per thread: balanced binary search tree of unique app function identifiers that are allowed to call the thread;
per app function: hash table of unique thread identifiers that are allowed to call the app function;
per thread: hash table of unique identifiers of app functions that the thread is allowed to call.

One embodiment provides that the step of checking at runtime by means of the third authorization matrix whether a process executes only the threads assigned thereto includes one or more of the following measures:
per process: a bit vector with length equal to the number of threads, set bit i means process is allowed to execute app thread;
per thread: a bit vector with length equal to the number of processes, set bit i means thread is allowed to be executed by process;
per process: sorted list of unique thread identifiers that the process is allowed to call, wherein by means of a binary search it is checked whether the process is allowed to execute the thread in that the binary search searches for the thread identifier of the thread to be executed in the sorted list of unique thread identifiers;
per thread: sorted list of unique process identifiers from which a thread is allowed to be executed, wherein by means of a binary search it is checked whether the thread is allowed to be executed by a process in that the binary search searches for the process identifier of the executing process in the sorted list of unique process identifiers;
per process: balanced binary search tree of unique thread identifiers that the process is allowed to execute;
per thread: balanced binary search tree of unique process identifiers that are allowed to execute the thread;
per process: hash table of unique thread identifiers that the process is allowed to execute;
per thread: hash table of unique identifiers of processes that are allowed to execute the thread.

One embodiment provides that the firmware of the measuring transducer comprises the first, second and/or third authorization matrix.

One embodiment provides that the operating system of the measuring transducer is designed as a real-time operating system.

One embodiment provides that the program code further comprises at least: a main logic; and one or more system call stubs by means of which functions in the basic system are called.

One embodiment provides that the firmware of the measuring transducer implements a virtual machine in which the app is executed.

One embodiment provides that the virtual machine is designed as a just-in-time compiler, ahead-of-time compiler, hypervisor or a combination thereof, and the app is available in a corresponding format on the basic system.

One embodiment provides that a plurality of interpreters/compilers/hypervisors can be executed in the measuring transducer; only one app is executed per interpreter/compiler/hypervisor.

The object is further achieved by a measuring transducer for executing some steps of the procedure as described above, comprising a data processing unit with a memory.

The object is further achieved by a computer program product comprising program instructions which, when executed on a measuring transducer, cause the measuring transducer to execute at least some steps of the procedure as described above.

The aim is further achieved by a computer-readable medium on which the computer program as described above is stored.

### BRIEF DESCRIPTION OF THE DRAWINGS

This is explained in more detail with reference to the following figures.

FIG. 1 shows a measuring transducer according to the present disclosure.

FIG. 2 shows a (virtual) host architecture.

FIG. 3 shows an implementation of the host architecture from FIG. 2.

FIGS. 4a/b show the app and the interaction of the app with the measuring transducer.

In the figures, the same features are labeled with the same reference signs.

### DETAILED DESCRIPTION

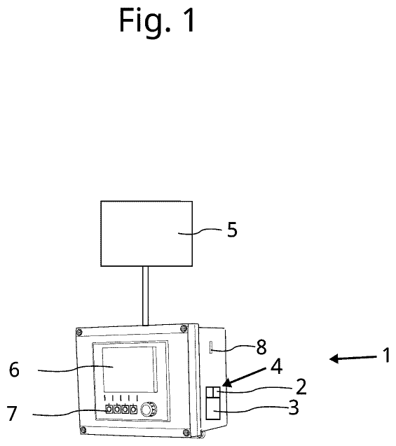

The measuring transducer in FIG. 1 will be discussed first. Generally speaking, a measuring transducer 1, also called a transmitter, is a device that converts an input variable into an output variable according to a fixed relationship. “Measuring transducer” and “transmitter” are used synonymously herein. A sensor is connected to a measuring transducer. Its raw measured values are processed in the measuring transducer, e.g., averaged or converted by means of a computation model to another variable-for example, the process variable to be determined-and possibly transmitted-to a control system, for example.

A wide variety of sensors (not shown) can be connected to the measuring transducer 1. Under the aforementioned name, “Memosens,” the applicant markets sensors for measuring pH value, conductivity, oxygen, turbidity, and other things.

The measuring transducer can also be an integral part of a sensor.

The measurement principle implemented in sensors can often be used in more applications than originally provided. For example, a turbidity sensor which was actually developed for the measurement of sludges in the field of wastewater would also be able to measure fat content in milk by using the measurement principle. In order to be able to flexibly provide new applications, the corresponding models are not permanently saved in the sensor, but can be reloaded in the form of apps 2.

The app 2 is thus a (re) loadable piece of program code which offers additional or different functions to the measuring transducer. The firmware of the measuring transducer is therefore designed such that apps can be received, (internally) stored, and executed via an interface. Apps 2 can be loaded onto the measuring transducer 1 via an interface 8. Likewise, sensors connected to measuring transducer 1 can bring “their” app and send it to the measuring transducer 1 via the cable. Wireless transmission, for example via Bluetooth, is also possible.

The loadable code of the app 2 is structured to be able to interact at two ends with the measuring transducer 1:
There are one or more app functions 22 in the app 2 that the measuring transducer 1 calls to retrieve a particular functionality in the app 2; example: calculation of measured values
The measuring transducer 1 in turn provides functions via one or more system calls 25, which are called via system call stubs 24 within the app 2; example: access to data structures, sensor parameters, sensor configuration, or expanded computational procedures.

The execution of the app 2 is denied, for example, if the system calls 25 or app function 22 are not present or are present only in an incompatible version or do not match the target system, i.e., the app 2 has been written for a wrong system 1. The app 2 is terminated if it tries during runtime to execute a system call 25 that is not present in the system 1 or is present in an incompatible version.

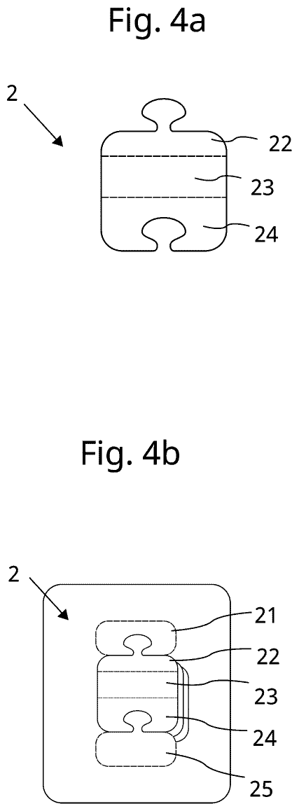

This is also shown by the general representation of the app 2 in FIG. 4a. The program code comprises three parts: the actual main logic 23, one or more app functions 22 which are called by the measuring transducer 1, and one or more system call stubs 24 on the basis of which functions in the measuring transducer 1 are called.

An app 2 can only run on a basic system 1 if the app 2 offers the functions 22 that the measuring transducer 1 expects and, conversely, the measuring transducer 1 offers the system calls 25 that the app 2 expects.

App functions 22 and system calls 25 represent the interfaces between the app 2 and the measuring transducer 1. Since these are intended to be expandable over time in a backwards compatible manner, the interfaces are preferably to be versioned.

The code of the app 2 can consist of any algorithms.

The main logic 23 can be designed, for example, to convert the raw values of a sensor connected to the measuring transducer 1 into measured values. Raw values are the physical parameters such as a voltage value, while the measured value represents for example the fat content of milk or a concentration of a specific substance in the medium to be measured. The app functions 22, for example, provide entry points for calculating measured values. For example, the measuring transducer 1 can provide the app function 22 with the current raw values of the sensor as parameters, or the app 2 can query the current raw values of a sensor via an API. The app 2 supplies the measured values, optionally with the particular unit, back to the measuring transducer 1, for example as a return value or by the measuring transducer 1 offering an API by which the app communicates the current measured value and the unit.

As shown in FIG. 4b by means of the stack, a plurality of apps 2 can be run simultaneously, but all apps 2 for the same type have the same interfaces. In one embodiment, apps 2 run in an isolated environment in order to prevent a defective app 2 from causing the measuring transducer 1 to crash completely. Due to this isolation, the measuring transducer 1 cannot directly call a function in the app 2. The app 2 also cannot perform direct calls to the measuring transducer 1. Apps 2 also run in their own address space and by default cannot access data of the measuring transducer 1.

In order to interact with an app 2, there are interface stubs 21 on the measuring transducer side. An app 2 is “entered and exited” only via the interface stubs 21. If the measuring transducer 1 calls a stub 21, a dispatch mechanism jumps into the app 2 and calls the corresponding function procedure 22. The corresponding function 22 calls the main logic 23, which executes its function and returns. The main logic 23 can also access system calls 25. In this case, the main logic 23 calls a system call stub 24 and a dispatch mechanism in turn forwards a system call 25 on the measuring transducer side. Now, execution again occurs in the measuring transducer 1, the system call 25 executes its action, then returns to the app 2, and the app 2 finally returns to the measuring transducer 1. The application code can consist of a main loop so that this cycle can be repeated forever.

Each app-capable firmware of the basic system 1 must specify the interface(s), i.e., the functions 22 which must implement the apps 2 for this type of measuring transducer 1. Since interfaces can develop further over time, the interfaces are preferably versioned.

One or more of the mentioned sensors can be connected to a measuring transducer 1, for example via a cable. Up to eight sensors, for example, can be connected to the measuring transducer 1. The raw measured values of the sensor are processed in the measuring transducer 1, e.g., averaged and/or converted by means of a computation model to another variable-for example, the process variable to be determined-and possibly transmitted-to a control system, for example. The measuring transducer 1 comprises a data processing unit 3 with a memory 4 that is large enough to store a plurality of apps 2.

A sensor comprises at least one sensor element for detecting a measurand of process automation. The sensor is then for example a pH sensor, also known as ISFET, generally an ion-selective sensor, a sensor for measuring redox potential, the absorption of electromagnetic waves in the medium, for example with wavelengths in the UV, IR and/or visible ranges, oxygen, conductivity, turbidity, the concentration of non-metallic materials or temperature with the corresponding measured variable.

The measuring transducer 1 can be connected to a superordinate unit 5, such as a control system, via a communication interface. The measuring transducer 1 forwards the measurement data to a control system. In this case, the control system is designed as a process control system (PLC), PC, or server. For this purpose, the measuring transducer 1 transmits the data via a communication protocol that the control system can understand, for example a fieldbus, such as HART, Profibus PA, Profibus DP, Foundation Fieldbus, Modbus RS485, or also an Ethernet-based fieldbus, such as EtherNet/IP, Profinet, or Modbus/TCP.

The measuring transducer 1 comprises a display 6 and one or more operating elements 7, e.g., knobs or rotary knobs, buttons or soft keys, via which the measuring transducer 1 can be operated. Measurement data of the sensor are, for example, displayed by the display 6. The sensor can likewise be configured and parameterized via the operating elements 7 and the corresponding view on the display 6. The display 6 may also be designed as a touch display; the operating elements 7 can then also be part of the touch display, i.e., as touch operating elements. The measuring transducer 1 comprises the data processing unit 3. The measuring transducer 1 can also comprise an SD card slot 8 via which apps can be loaded onto the measuring transducer 1. The measuring transducer 1 can also comprise one or more wireless modules, such as Bluetooth, mobile radio (2G, 3G, 4G, 5G) or other, possibly also wireless, bus protocols, such as WirelessHART, by means of which apps 2 can be loaded.

As mentioned, the measuring transducer 1 or the sensors connected thereto can be operated and parameterized via the operating elements 7. To this end, a menu or the menu structure is shown on the display 6. The menu structure describes the hierarchy, navigation, and texts of the various menu pages that are shown on the display 6. The menu structure makes it possible to select the desired command from an offering and to have it executed.

The operating system of the measuring transducer 1 is designed as a real-time operating system.

The following defines terms that are important for the further course of the description.

A “process” is a computer program at runtime. More precisely, a process is the concrete instantiation of a program for its execution within a computer system, supplemented by further (administrative) information and resource allocations of the operating system for this execution. A process is the execution environment for a program on a computer system. A “process” is identified by the reference sign 11. If several processes are mentioned in one example, they are marked with subscript numbers, for example, if there are two processes, “111” and “112” or with a number of n processes, the i-th process is “11i.”

A “thread” is a line of execution or an execution sequence in the processing of a program. A thread is part of a process. Threads in the narrow sense, sometimes called kernel threads, run under the control of the operating system. A (kernel) thread is a sequential execution run within a process and shares a number of resources with the other existing threads (multithreading) of the associated process, such as the code segment, the data segment, and the file descriptors used.

Threads within the same process can be assigned to different processors. A “thread” is identified by the reference sign 12. If several threads are mentioned in an example, they are marked with subscript numbers, for example, for two threads, “121” and “122” or with a number of n threads, the i-th thread is “12i.”

A “system call” is an interface for the application logic of a thread to access system resources or functionality, for example functions for sensor communication via a serial interface of the measuring transducer 1. A “system call” is identified by the reference sign 25. If several system calls are mentioned in one example, they are marked with subscript numbers, for example, for two system calls, “251” and “252” or with a number of n system calls, the i-th system call is “25i ”.

A “subsystem” is a logically related component that manages system resources or functionality. The application logic gains access to the functions of a subsystem via system calls. In the further description, it is then understood that system calls implement, manage or are assigned to a subsystem. In this application, the terms system call and subsystem are strictly distinguished only where necessary and are otherwise used synonymously.

As a special feature, there may be system resources as system elements of a computer system (hardware or software) that can or are only allowed to be used by a single process. For example, the serial interface of measuring transducer 1 intended for sensor communication could be assigned to exactly one process, so that only this process is allowed to use system calls for sensor communication.

Since threads assigned to the same process use the same memory address space, communication between these threads is very easy from the outset.

As part of this application, system calls 25 (see below) are hosted by one or more processes 11. A thread 12 is allowed to only call a system call 25 if the process 11 assigned to thread 12 hosts the system call 25.

Other system resources are not exclusively bound to processes. This means that they can be used jointly by all threads from all processes. The shared use of resources can also result in conflicts. These must be resolved by using synchronization mechanisms.

One such measure is “mutual exclusion,” also called locking or mutual exclusion. Critical sections that would lead to conflicts without synchronization measures when sharing system resources (i.e., the simultaneous use of system calls 25 from multiple processes 11) are protected by lock variables, also called mutexes or semaphores. The program code that manages a system resource is therefore executed from all processes 11.

Another measure is message exchange, also called message passing. Here, the program code that manages a system resource is only executed from exactly one process 11. Calling processes 11 that want to access the system resource via system calls 25 send a message to the implementing process 11.

For example, to prevent the long-running signal processing from slowing down the GUI system, the signal processing and the parameter system (see below) must run in separate threads in order to decouple the two processing threads from one another. Subsystems, such as sensor communication, are partially assigned to one or more operating system processes and are only allowed to be used within these assigned processes using system calls 25. Operating system processes are often also referred to as host processes, in this case the processes 11 on the measuring transducer 1.

If the measuring transducer 1 is now made app-capable as described above and a virtual machine (VM) is used for this purpose (see the virtual machine below), the situation changes as follows: the host processes become virtual processors for the app 2 that execute VMs; the application logic migrates completely or in part from the usual native host implementation to app threads 12 and the app threads 12 are executed in the virtual machines in the context of the processes 11 on the measuring transducer 1. This will first be explained by way of an example.

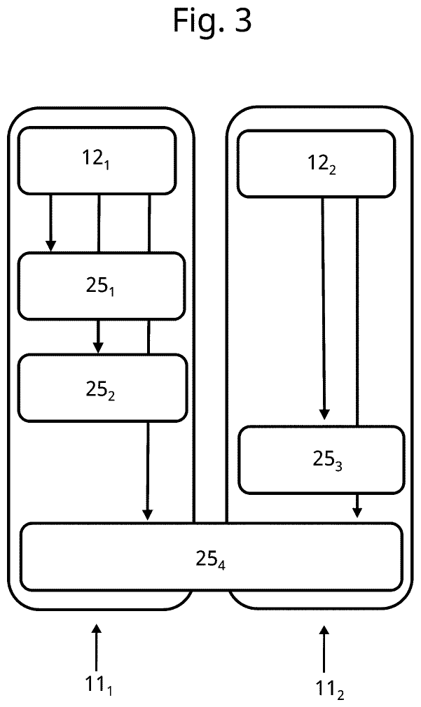

In analogy to a general-purpose operating system, it initially makes sense to execute any app thread 12 on any host process 11. However, such an embodiment is generally not possible on the app-enabled field device 1, the firmware of which was subsequently extended to allow apps to be loaded, or only after massive (error-prone) refactoring of the firmware. The reason for this is that on such a firmware based on a real-time operating system, the host processes are not equivalent and host different subsystems in addition to the VMs. Assume that a first subsystem is addressed via (first) system calls 251 and is assigned to a first host process 111. Then only the app thread 121 running in host process 111 is allowed to call system calls 251. For an illustration, see FIG. 3. A second app thread 122, which runs on a second host process 112, is therefore not allowed to call any functionality in the first process 111 since otherwise serious errors such as data corruption with consequences such as system crashes can occur: the first subsystem managed via the (first) system calls 251 is not prepared for the data it manages to be changed by other processes or threads during processing.

In an app-enabled system in which apps allow multiple quasi-parallel threads via multithreading, a predetermined system architecture does not exist: the app code cannot know the system architecture of all host systems on which it is executed. Without the measure according to the present disclosure, the app code can therefore execute arbitrary, undefined accesses, which means that a stable system operation cannot be ensured.

Thus, system calls 25 are initially provided by the measuring transducer 1. System calls 25 are implemented on the host 1 and provide functions for the plug-ins 2 (“apps”). For example, the measuring transducer 1 can provide procedures for reading or writing particular memory regions via system calls 25. System calls 25 are, for example, defined by a versioned interface specification. Other examples are sensor parameters, sensor configuration or expanded computing procedures. System calls 25 have a name, a unique identifier (system call identifier) and a version. The same applies to the procedures of the system calls 25 as for an app function 22 (see below).

Instead of refactoring the firmware (which is prone to errors) of the measuring transducer so that all system calls 25 can be called from all app threads 12 from all host processes 11, the present disclosure restricts degrees of freedom that are not necessary for the successful execution of the app. Refactoring efforts in the firmware to support apps are thus minimized:

An app 2 comprises at least program code with at least one app function 22, as well as one or more threads 12, wherein each app function 22 is associated to one or more threads 12. It is determined which system calls 25 each thread 12 calls. Finally, it is checked at runtime by means of an authorization matrix whether the thread 12 actually only calls the system call(s) 25 to which the thread 12 is authorized. If authorization is present, an execution of the system call 25 takes place, and if an authorization is not present, the app 2 is terminated.

The above specification must be enforceable at runtime. At the development time of the app 2, it must preferably be possible to determine which app threads 12 an app 2 consists of and which subsystems they call. Such a procedure limits unnecessary degrees of freedom in the allocation of app threads 12 to processes 11 on the measuring transducer 1 and therefore simplifies the implementation of the measuring transducer, since interactions between app and host (measuring transducer) that were excluded from the outset no longer have to be considered in the implementation. A correct implementation of the system calls 25 including assignment to host processes 11 must therefore consider far fewer interaction possibilities. This greatly simplifies the (subsequent) implementation of expandability through apps in the measuring transducer.

The app interface description of the measuring transducer therefore states. which app functions 22 must provide an app 2 running on the measuring transducer 1,
which system calls 25 the measuring transducer 1 offers to the apps 2,. which app threads 12 an app 2 consists of,
which app threads 12 offer the app functions 22, and
which system calls 25 an app thread 12 calls.

This interface description can be called virtual host architecture or virtual measuring transducer architecture.

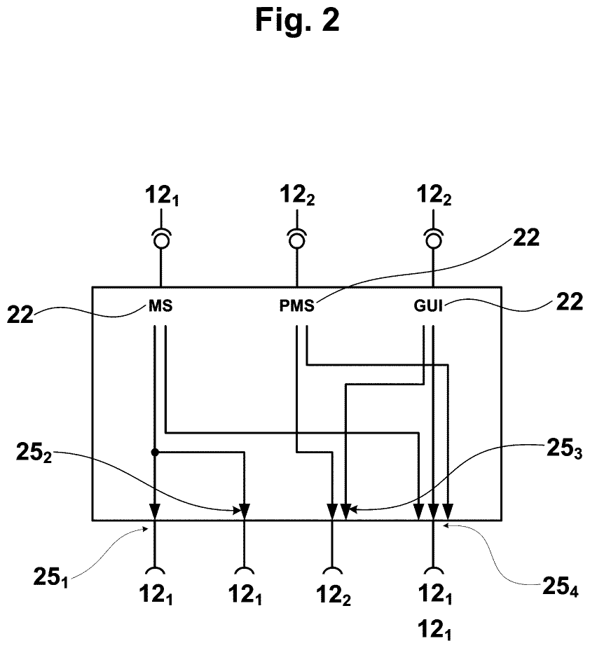

FIG. 2 shows a (virtual) host architecture according to the claimed procedure. FIG. 2 shows how a certain number of threads 12 can access a certain number of system calls 25 and which threads 12 offer which app functions 22; this is also referred to as app interface thread deployment.

The app 2 uses two threads here, 121 and 122. These are necessary for the measured value processing MS, the parameter system PMS and the graphical user interface GUI. The measuring transducer 1 offers the system calls 251, 252, 253 and 254. The first thread 121 offers the host 1 app functions 22 for access to the measured value processing MS. The second thread 122 offers the host app functions 22 for the parameter system PMS and the graphical user interface GUI.

The principle is that a thread 12 “docks” at the top and thus makes computing time available to the inner code of the app in its relevant context. The routines running there can now in turn call system calls 25 on the host side. These run in the context of the relevant thread 12, which executes the relevant code. It is now important to prevent every thread 12 from being allowed to call every (arbitrary) system call 25, since the system calls implemented there can typically only be executed safely in a specific context (i.e., a specific thread). To be able to let every thread 12 call every system call 25, the overhead on the host side would increase enormously.

The app interface thread deployment from FIG. 2 now specifies in a binding manner: the threads 12 “coming in” at the top can only “come out” at the bottom with very specific system calls 25. The host 1 now only has to functionally ensure this binding set of possibilities in order to be able to execute app 2 correctly.

In summary, the threads 12 call into the app at the top and come out at the bottom of the system calls 25 that may be triggered on the host and the listed thread identifiers indicate which thread 12i is allowed to occur at which system call 25i.

The circles at the top of FIG. 2 indicate functionalities provided by the app 2. These are

allocated to app threads. The functionality implemented behind the “circles” triggers system calls. Since the “circles” run within app threads 12, the system calls 25 are ultimately also executed by app threads 12, which in turn run on host processes 11. Therefore, you can see in FIG. 2 below which app thread 12i can ultimately trigger which system call 25i (or is allowed to execute according to the virtual host architecture).

The number n of supported app threads 12 is in principle unlimited by the app 2 but fixed per host architecture, while the number of system calls 25 is finite.

If a virtual host architecture is given, a developer of the firmware of the measuring transducer must define how the threads 12 and system calls 25 are mapped to the host processes 11, i.e., how the virtual host architecture can be specifically implemented on the measuring transducer 1.

The type of implementation, i.e., the interface description, is known to the measuring transducer 1 and stored in the firmware. From the interface specification, data structures can be generated that are required to check the authorizations (see below).

In one embodiment, all apps 2 have the same interface description or the apps 2 must adhere to the same interface. As a result, as long as the interface remains unchanged, no firmware update of the host is necessary. If the interface evolves and an app 2 requests the newer version of the interface, a firmware update is required.

In one embodiment, a measuring transducer 1 supports a plurality of versions of an interface. Then the software architecture of the measuring transducer 1 is designed to map the virtual host architectures of all interfaces to be supported.

For measuring transducers executing apps 2 with the interface described above, the firmware is implemented to comply with the virtual host architecture.

As mentioned, the system calls 25 are implemented in such a way that they can be called directly by function calls from all app threads 12 used and their respective host processes 11. Thus, a host process 11 directly accesses the data of the subsystem managed by system call 25 (shared memory approach). To avoid conflicts caused by simultaneous access by multiple host processes 11, locks are used.

Alternatively, the developer of the firmware of the measuring transducer may choose to map a subsystem including associated system calls 25, as well as all app threads 12 that call these system calls 25, to a single host process 11. This eliminates the need for the above-mentioned coordination of several host processes 11 with regard to the system calls 25 including the associated subsystem.

Another alternative is to implement the subsystem for the corresponding system call 25 in a single first host process 11. App threads 12 mapped to other host processes 11 can request system calls 25 via message passing. The subsystem assigned to system call 25 then runs only in the first host process 11, processes the requests and then sends response messages to the other host processes 11 and the app threads 12 running there.

It is the responsibility of the developer of the firmware of the measuring transducer to choose a distribution of system calls 25 and app threads 12 to host processes 11 that is sent to the firmware, including the appropriate implementation strategy just described. It is also conceivable to choose a different strategy for each system call 25.

Instead of spending a lot of effort on generically preparing the firmware of the measuring transducer so that every app thread could use every system call, the complexity of the host-side implementation is now reduced by defining a virtual host architecture.

FIG. 3 shows an implementation for the virtual host architecture from FIG. 2. The system calls 25 allowed to the app threads 12 are shown with arrows. All other calls are not allowed.

Two host processes 111 and 112 are running on the measuring transducer 1. These contain virtual machines for executing the app threads 121 and 122 of the app 2. These act as virtual processors for the two app threads 121 and 122. The first and second system call 251 or 252 can be assigned exclusively to the first process 111 and can be called from thread 121. Accordingly, no implementation is necessary to make this usable, also from the second app thread 122 (and thus from the host process 112). The third system call 253 is exclusively assigned to the second process 112 and the second thread 122. The fourth system call 254 is needed from both threads 121 and 122. The “shared memory” approach is implemented in the example: the subsystem assigned to the system call 254 is implemented in such a way that it can be called directly from the first host process 111 and the second host process 112 via a function call. This extends accordingly across both processes 111 and 112. The subsystem assigned to the fourth system call 254 must use locks if it contains data structures or resources that must be protected from simultaneous access by the host processes 111 and 112.

At runtime of app 2, the measuring transducer 1 must enforce that app threads 12 only call system calls 25 to which they are authorized. If an app thread 12 calls a system call 25, then:
the VM adds at least one identification of the calling app thread 12 to the system call 25, e.g., a thread identifier;
when entering the system call 25, the system call 25 must check using the thread identifier whether the app thread 12 is authorized to call system call 25;
if an authorization is present, the system call 25 is executed;
if an authorization is not present, the app 2 is terminated, e.g., with an error message; another alternative is not to abort app 2, but to have system call 25 return an error code to which app 2 must react in a suitable manner, e.g., by terminating with an error.

A variety of algorithms and data structures can be used to check whether a thread 12 is authorized to execute a system call 25. For this purpose, an authorization matrix is used in which, for example, a Boolean value for the authorization definition is stored for each combination of app thread 12 and system call 25.

Possible implementations of this are:
per system call 25: a bit vector with length n equal to the number of threads 12, set bit i means thread 12; is allowed to call the relevant system call 25;
per thread 12: a bit vector with length n equal to the number of system calls 25, set bit i means thread 12 is allowed to call system call 25ᵢ;
per system call 25: sorted list of unique thread identifiers that are allowed to call the system call 25, wherein by means of a binary search it is checked whether the system call 25 is allowed to be called by a thread 12 in that the binary search searches for the thread identifier of the calling thread 12 in the sorted list of unique thread identifiers;
per thread 12: sorted list of unique system call identifiers that a thread 12 is allowed to call, wherein by means of a binary search it is checked whether the thread 12 is allowed to call a system call 25 in that a binary search searches for the system call identifier of the system call 25 to be called in the sorted list of unique system call identifiers;
per system call 25: (balanced) binary search tree of unique thread identifiers that are allowed to call system calls 25;
per thread 12: (balanced) binary search tree of unique system call identifiers that the threads 12 are allowed to call;
per system call 25: hash table of unique thread identifiers that are allowed to call system call 25; or
per thread 12: hash table of unique identifiers of system calls 25 that the thread 12 is allowed to call.

Conversely, it must also be enforced that a host process 11 only calls those functions 22 that an app thread 12 makes available to it. The same problems as with system calls 25 also apply when calling app functions 22. Similar to the system calls 25 and the app threads 12, a (second) authorization matrix is introduced that specifies whether the host process is allowed to call an app function 22 for a thread 12. If a host process 11 wants to call an app function 22 on an app thread 12, the second authorization matrix is checked beforehand. If app thread 12 executed by host process 11 does not have authorization, this is treated as a firmware implementation error in the host. The possible algorithms and data structures for checking the authorizations are analogous to those for the system calls 25, so the second authorization matrix can be implemented as follows:
per app function 22: a bit vector with length equal to the number of threads 12, set bit i means thread 12; is allowed to call the relevant app function 22;
per thread 12: a bit vector with length equal to the number of app functions 22, set bit i means thread 12 is allowed to call app function 22ᵢ;
per app function 22: sorted list of unique thread identifiers that are allowed to call the app function 22, wherein by means of a binary search it is checked whether the app function 22 is allowed to be called by a thread 12 in that the binary search searches for the thread identifier of the calling thread 12 in the sorted list of unique thread identifiers;
per thread 12: sorted list of unique app function identifiers that a thread 12 is allowed to call, wherein by means of a binary search it is checked whether the thread 12 is allowed to call an app function 22 in that the binary search searches for the app function identifier of the app function 22 to be called in the sorted list of unique app function identifiers;
per app function 22: (balanced) binary search tree of unique thread identifiers that are allowed to call app functions 22;
per thread 12: (balanced) binary search tree of unique app function identifiers that are allowed to be called by thread 12;
per app function 22: hash table of unique thread identifiers that are allowed to call the app function; or
per thread 12: hash table of unique identifiers of app functions 22 that the thread 12 is allowed to call.

Furthermore, it must be ensured that a host process 11 only executes the app threads 12 assigned thereto. This is checked via a (third) authorization matrix. This third authorization matrix is not derived from the virtual host architecture, but results from the chosen implementation of the virtual host architecture by the firmware developer of the measuring transducer. The third authorization matrix can be implemented as follows:
per host process 11: a bit vector with length equal to the number of threads 12, set bit i means host process 11 is allowed to execute app thread 12ᵢ;
per thread 12: a bit vector with length equal to the number of host processes 11, set bit i means thread 12 is allowed to be executed by host process 11ᵢ;
per host process 11: sorted list of unique thread identifiers that the host process 11 is allowed to call, wherein by means of a binary search it is checked whether the host process 11 is allowed to execute the thread 12 in that the binary search searches for the thread identifier of the thread 12 to be executed in the sorted list of unique thread identifiers;
per thread 12: sorted list of unique host process identifiers from which a thread 12 is allowed to be executed, wherein by means of a binary search it is checked whether the thread 12 is allowed to be executed by a host process 11 in that a binary search searches for the host process identifier of the executing host process 11 in the sorted list of unique host process identifiers;
per host process 11: (balanced) binary search tree of unique thread identifiers that host process 11 is allowed to execute;
per thread 12: (balanced) binary search tree of unique host process identifiers that are allowed to execute thread 12;
per host process 11: hash table of unique thread identifiers that host process 11 is allowed to execute; or
per thread 12: hash table of unique identifiers of host processes 11 that are allowed to execute the thread 12.

As mentioned, the measuring transducer 1 must be able to load and execute apps 2, for example by the firmware implementing a virtual machine in which apps 2 are interpreted/executed. The virtual machine is designed as an interpreter, such as an emulator, as an ahead-of-time compiler, just-in-time compiler, hypervisor, or a combination thereof. The CPU architecture of the measuring transducer and the connected device with the app 2 running on it do not necessarily have to be the same. In the case of hypervisors, however, it is advisable for a performing embodiment of the app to select the same CPU command set.

In the embodiment as a virtual machine, inherent measures for memory protection, and thus also security, are obtained. A possible malicious code cannot reach beyond the virtual machine and, as a result, cannot negatively affect the firmware or other virtual machines that are running (a plurality can run in parallel, see below). There is a separation between the different virtual machines, because no common memory regions are used. The different virtual machines interact only via defined interfaces, so that only limited functions can be executed thereby. The virtual machine, in its embodiment as an interpreter (emulator), forms an environment for executing the app in the form of a virtual CPU with a virtual working memory. This system is, in this case, isolated from the rest of the system, i.e., from the host system, i.e., from the firmware of the sensor. If an app is defective, it does not affect the rest of the system. The rest of the system continues to run, even if the defective extension crashes. Communication is carried out via defined interfaces.

However, the app 2 can also be run “natively” on the measuring transducer 1. For this purpose, the measuring transducer 1 comprises, for example, an ahead-of-time compiler or a just-in-time compiler. The app 2 is present in a corresponding format on the basic system 1.

If emulation does not take place via a virtual machine (see above) and the CPU architectures of host and guest match, support of the processor of the measuring transducer 1 is necessary to execute the app; e.g., a memory management unit (MMU) is then needed in hardware so that the memory protection can be realized.

For apps 2 to be interpreted/run, the app 2 must contain program code that is interpretable/runnable, or that can be converted into an interpretable/runnable form, for example machine-independent byte code. Likewise, the program must be stored in a binary format, for example in the executable and linking format (ELF). The binary format provides information about the memory layout of the app, e.g., the position and size of the code and data. This information is necessary for loading an app 2 and for preparing it to run.

The program code can be executed via an interpreter (virtual machine) or can be translated before execution into the machine code of the processor used on the basic system (compiler).

1. A procedure for executing an app on a measuring transducer of process automation technology,
wherein the firmware of the measuring transducer is designed to receive and store apps,
wherein the measuring transducer is designed to execute one or more processes,
the procedure comprising the steps:
providing system calls from the measuring transducer;
transmitting the app to the measuring transducer if the app is not yet located on the measuring transducer,
wherein the app comprises at least program code with at least one app function, and generates and executes one or more threads at runtime,
wherein each app function is assigned to one or more threads,
wherein it is determined which system calls each thread is authorized to use, and
wherein it is determined which thread is executed in which process; and
executing the app on the measuring transducer;
and at least one of the procedure steps a), b), and/or c), comprising
a) checking at runtime by means of a first authorization matrix whether the thread actually only uses the system call(s) to which the thread is authorized:
if authorization is present, an execution of the system call takes place, and
if no authorization is present, the app is terminated;
b) checking at runtime by means of a second authorization matrix whether a process only calls those functions that a thread makes available to it:
if authorization is present, an execution of the function takes place, and
if no authorization is present, treatment as a firmware implementation error in the host takes place;
c) checking at runtime by means of a third authorization matrix whether a process only executes the threads assigned thereto:
if authorization is present, the thread is executed by the process, and
if no authorization is present, treatment as a firmware implementation error in the host takes place.

2. The procedure according to claim 1,
wherein a system call can be called by more than one thread and the shared resources are jointly protected against parallel access by a suitable protection mechanism.

3. The procedure according to claim 1,
wherein a system call and threads calling it are mapped to a single process.

4. The procedure according to claim 1,
wherein the step of checking at runtime by means of the first authorization matrix whether the thread actually only uses the system call(s) to which the thread is authorized comprises one or more of the following measures:
per system call: a bit vector with length equal to the number of threads, set bit i means thread is allowed to call the relevant system call;
per thread: a bit vector with length equal to the number of system calls, set bit i means thread is allowed to call system call;
per system call: sorted list of unique thread identifiers i that are allowed to call the system call, wherein by means of a binary search it is checked whether the system call is allowed to be called by a thread;
per thread: sorted list of unique system call identifiers i that a thread is allowed to call, wherein by means of a binary search it is checked whether the thread is allowed to call a system call;
per system call: balanced binary search tree of unique thread identifiers i, corresponding to the threads that are allowed to call system calls;
per thread: balanced binary search tree of unique system call identifiers i, corresponding to the system calls that the thread is allowed to call;
per system call: hash table of unique thread identifiers i, corresponding to the threads that are allowed to call system call;
per thread: hash table of unique system call identifiers i, corresponding to the system calls that the thread is allowed to call.

5. The procedure according to claim 1,
wherein the step of checking at runtime by means of a second authorization matrix whether a process only calls those functions that a thread makes available to it comprises one or more of the following measures:
per app function: a bit vector with length equal to the number of threads, set bit i means thread is allowed to call the relevant app function;
per thread: a bit vector with length equal to the number of app functions, set bit i means thread is allowed to call app function;
per app function: sorted list of unique thread identifiers that are allowed to call the app function, wherein by means of a binary search it is checked whether the app function is allowed to be called by a thread in that the binary search searches for the thread identifier of the calling thread in the sorted list of unique thread identifiers;
per thread: sorted list of unique app function identifiers that a thread is allowed to call, wherein by means of a binary search it is checked whether the thread is allowed to call an app function in that the binary search searches for the app function identifier of the app function to be called in the sorted list of unique app function identifiers;
per app function: balanced binary search tree of unique thread identifiers that are allowed to call app function;
per thread: balanced binary search tree of unique app function identifiers that are allowed to call the thread;
per app function: hash table of unique thread identifiers that are allowed to call app function;
per thread: hash table of unique identifiers of app functions that the thread is allowed to call.

6. The procedure according to claim 1,
wherein the step of checking at runtime by means of the third authorization matrix whether a process executes only the threads assigned thereto comprises one or more of the following measures:
per process: a bit vector with length equal to the number of threads, set bit i means process is allowed to execute the app thread;
per thread: a bit vector with length equal to the number of processes, set bit i means thread is allowed to be executed by process;
per process: sorted list of unique thread identifiers that the process is allowed to call, wherein by means of a binary search it is checked whether the process is allowed to execute the thread in that the binary search searches for the thread identifier of the thread to be executed in the sorted list of unique thread identifiers;
per thread: sorted list of unique process identifiers from which a thread is allowed to be executed, wherein by means of a binary search it is checked whether the thread is allowed to be executed by a process in that the binary search searches for the process identifier of the executing process in the sorted list of unique process identifiers;
per process: balanced binary search tree of unique thread identifiers that process is allowed to execute;
per thread: balanced binary search tree of unique process identifiers that are allowed to execute thread;
per process: hash table of unique thread identifiers that the process is allowed to execute;
per thread: hash table of unique identifiers of processes that are allowed to execute the thread.

7. The procedure according to claim 1,
wherein the firmware of the measuring transducer comprises the first, second and/or third authorization matrix.

8. The procedure according to claim 1,
wherein the operating system of the measuring transducer is designed as a real-time operating system.

9. The procedure according to claim 1,
wherein the program code further comprises at least:
a main logic; and
the system call stubs, by means of which functions in the basic system are called.

10. The procedure according to claim 1,
wherein the firmware of the measuring transducer implements a virtual machine in which the app runs.

11. The procedure according to claim 10,
wherein the virtual machine is designed as a just-in-time compiler, ahead-of-time compiler, hypervisor or a combination thereof, and the app is present in a corresponding format on the basic system.

12. The procedure according to claim 11,
wherein a plurality of interpreters/compilers/hypervisors can be executed in the measuring transducer.

13. A measuring transducer, comprising:
a data processing unit configured to execute a procedure; and
a memory;
wherein the data processing unit is further configured to execute an app on a measuring transducer of process automation technology,
wherein firmware of the measuring transducer is designed to receive and store apps, wherein the measuring transducer is designed to execute one or more processes,
the procedure comprising the steps:
providing system calls from the measuring transducer;
transmitting the app to the measuring transducer if the app is not yet located on the measuring transducer,
wherein the app comprises at least program code with at least one app function, and generates and executes one or more threads at runtime,
wherein each app function is assigned to one or more threads,
wherein it is determined which system calls each thread is authorized to use, and
wherein it is determined which thread is executed in which process; and
executing the app on the measuring transducer;
and at least one of the procedure steps a), b), and/or c), comprising
a) checking at runtime by means of a first authorization matrix whether the thread actually only uses the system call(s) to which the thread is authorized:
if authorization is present, an execution of the system call takes place, and if no authorization is present, the app is terminated;
b) checking at runtime by means of a second authorization matrix whether a process only calls those functions that a thread makes available to it:
if authorization is present, an execution of the function takes place, and if no authorization is present, treatment as a firmware implementation error in the host takes place;
c) checking at runtime by means of a third authorization matrix whether a process only executes the threads assigned thereto:
if authorization is present, the thread is executed by the process, and if no authorization is present, treatment as a firmware implementation error in the host takes place.

14. A computer program product comprising program instructions which, when executed on a measuring transducer, cause the measuring transducer to execute the following procedure:
wherein firmware of the measuring transducer is designed to receive and store apps, wherein the measuring transducer is designed to execute one or more processes,
the procedure comprising the steps:
providing system calls from the measuring transducer;
transmitting the app to the measuring transducer if the app is not yet located on the measuring transducer,
wherein the app comprises at least program code with at least one app function, and
generates and executes one or more threads at runtime,
wherein each app function is assigned to one or more threads,
wherein it is determined which system calls each thread is authorized to use, and
wherein it is determined which thread is executed in which process; and
executing the app on the measuring transducer;
and at least one of the procedure steps a), b), and/or c), comprising
a) checking at runtime by means of a first authorization matrix whether the thread actually only uses the system call(s) to which the thread is authorized:
if authorization is present, an execution of the system call takes place, and
if no authorization is present, the app is terminated;
b) checking at runtime by means of a second authorization matrix whether a process only calls those functions that a thread makes available to it:
if authorization is present, an execution of the function takes place, and
if no authorization is present, treatment as a firmware implementation error in the host takes place;
c) checking at runtime by means of a third authorization matrix whether a process only executes the threads assigned thereto:
if authorization is present, the thread is executed by the process, and
if no authorization is present, treatment as a firmware implementation error in the host takes place.

15. A computer-readable medium storing a computer program for executing the following procedure:
wherein firmware of the measuring transducer is designed to receive and store apps, wherein
the measuring transducer is designed to execute one or more processes,
the procedure comprising the steps:
providing system calls from the measuring transducer;
transmitting the app to the measuring transducer if the app is not yet located on the measuring transducer,
wherein the app comprises at least program code with at least one app function, and
generates and executes one or more threads at runtime,
wherein each app function is assigned to one or more threads,
wherein it is determined which system calls each thread is authorized to use, and
wherein it is determined which thread is executed in which process; and
executing the app on the measuring transducer;
and at least one of the procedure steps a), b), and/or c), comprising
a) checking at runtime by means of a first authorization matrix whether the thread actually only uses the system call(s) to which the thread is authorized:
if authorization is present, an execution of the system call takes place, and
if no authorization is present, the app is terminated;
b) checking at runtime by means of a second authorization matrix whether a process only calls those functions that a thread makes available to it:
if authorization is present, an execution of the function takes place, and
if no authorization is present, treatment as a firmware implementation error in the host takes place;
c) checking at runtime by means of a third authorization matrix whether a process only executes the threads assigned thereto:
if authorization is present. the thread is executed by the process, and
if no authorization is present, treatment as a firmware implementation error in the host takes place.
